(19) United States
(12) Patent Application Publication
(10) Pub. No.: US 2017/0075265 A1
(43) Pub. Date: Mar. 16, 2017

(54) FIXING DEVICE AND IMAGE FORMING APPARATUS

(71) Applicant: FUJI XEROX CO., LTD., Tokyo (JP)

(72) Inventors: Takahito CHIBA, Kanagawa (JP); Tsuyoshi SUNOHARA, Kanagawa (JP); Hidehiko YAMAGUCHI, Kanagawa (JP); Hideki MORIYA, Kanagawa (JP); Tomohiro WADA, Kanagawa (JP)

(73) Assignee: FUJI XEROX CO., LTD., Tokyo (JP)

(21) Appl. No.: 15/061,298

(22) Filed: Mar. 4, 2016

(30) Foreign Application Priority Data
Sep. 15, 2015 (JP) 2015-182318

(51) Int. Cl. G03G 15/20

(52) U.S. Cl. CPC G03G 15/2039

(57) ABSTRACT

A fixing device includes a detecting portion that detects a load applied to a driving portion configured to drive a fixing portion configured to fix an image formed on a medium, an identifying portion that identifies a type of the medium from a result of detection performed by the detecting portion, and a setting portion that sets a threshold with reference to which the identifying portion identifies the type of the medium. The threshold is set for each of different temperatures detected by a temperature detecting portion that detects a temperature of the fixing portion or for each predetermined number of media on which images are fixed.

### CROSS-REFERENCE TO RELATED APPLICATIONS

This application is based on and claims priority under 35 USC 119 from Japanese Patent Application No. 2015-182318 filed Sep. 15, 2015.

### BACKGROUND

### Technical Field

The present invention relates to a fixing device and an image forming apparatus.

### SUMMARY

According to an aspect of the invention, there is provided a fixing device including a detecting portion that detects a load applied to a driving portion configured to drive a fixing portion configured to fix an image formed on a medium, an identifying portion that identifies a type of the medium from a result of detection performed by the detecting portion, and a setting portion that sets a threshold with reference to which the identifying portion identifies the type of the medium. The threshold is set for each of different temperatures detected by a temperature detecting portion that detects a temperature of the fixing portion or for each predetermined number of media on which images are fixed.

### BRIEF DESCRIPTION OF THE DRAWINGS

An exemplary embodiment of the present invention will be described in detail based on the following figures, wherein:

FIG. 1 illustrates an outline configuration of an image forming apparatus according to the exemplary embodiment;

FIG. 2 is a block diagram illustrating relevant elements included in an electrical system of the image forming apparatus according to the exemplary embodiment;

FIG. 3 is a graph illustrating an exemplary current detected by a torque detecting unit;

FIG. 4 is a graph illustrating an exemplary case where the sheet type is identified with reference to a constant threshold;

FIG. 5 is a graph illustrating the current of a motor observed during image formation (a fixing-motor current), the temperature of a heating belt, and the temperature of a pressing roller that all change with time;

FIG. 6 is a graph illustrating an exemplary threshold (sheet-type-identification threshold) that is set in accordance with the temperature of the pressing roller;

FIG. 7 is a flow chart illustrating an exemplary process performed in the image forming apparatus according to the exemplary embodiment; and

FIG. 8 is a graph illustrating exemplary thresholds (sheet-type-identification thresholds) that are each set in accordance with the number of images formed (the number of pages).

### DETAILED DESCRIPTION

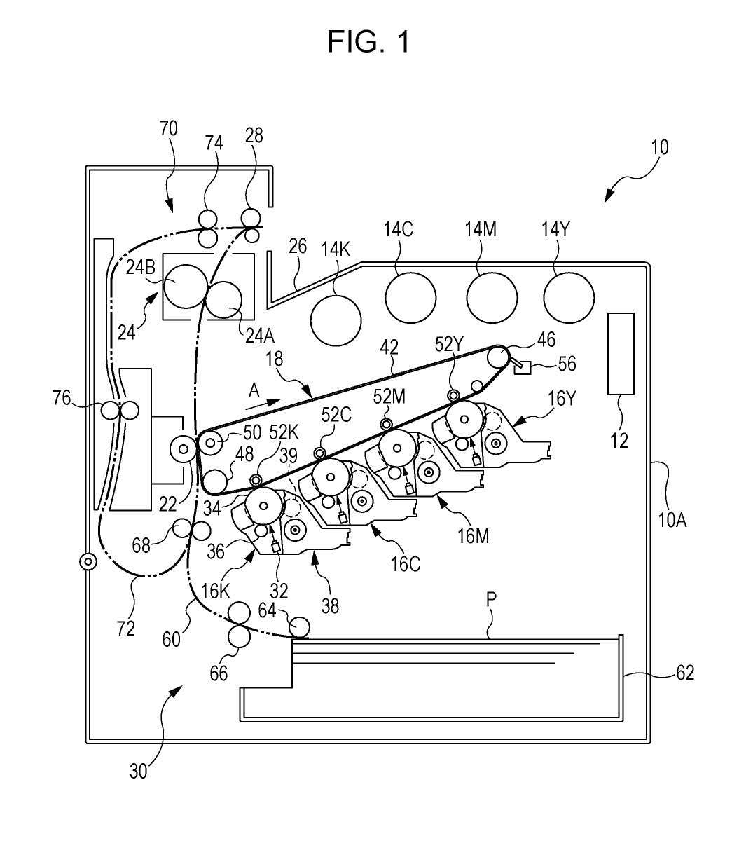

FIG. 1 illustrates an outline configuration of an image forming apparatus 10 according to an exemplary embodiment of the present invention.

Referring to FIG. 1, the configuration of the image forming apparatus 10 according to the present exemplary embodiment will first be described. Hereinafter, yellow is denoted by Y, magenta is denoted by M, cyan is denoted by C, and black is denoted by K. Furthermore, elements and toner images (or images) that need to be distinguished from one another by the above colors are denoted by reference numerals with suffixes Y, M, C, and K representing the above colors. If such elements or toner images are denoted collectively regardless of the colors, the suffixes given to the reference numerals are omitted.

### Overall Configuration

Referring to FIG. 1, the image forming apparatus 10 has an apparatus body 10A, in which an image processing portion 12 is provided. The image processing portion 12 processes image data inputted thereto into pieces of gray-scale data for the four respective colors Y, M, C, and K.

The apparatus body 10A further includes the following elements. Image forming units 16 as exemplary image forming portions that form toner images in the respective colors are provided in a central part of the apparatus body 10A and are arranged at intervals in a direction that is at an angle with respect to the horizontal direction. A first transfer unit 18 is provided above the image forming units 16. The toner images formed by the respective image forming units 16 are transferred to the first transfer unit 18 in such a manner as to be superposed one on top of another.

A second transfer roller 22 is provided on one side (the left side in FIG. 1) of the first transfer unit 18. The second transfer roller 22 transfers the toner images superposed on the first transfer unit 18 to a sheet P as an exemplary medium that is transported along a transport path 60 by a feed-and-transport unit 30 to be described later.

A fixing device 24 as an exemplary transporting device that nips and transports the sheet P is provided on the downstream side with respect to the second transfer roller 22 in a direction in which the sheet P is transported (hereinafter, the direction is referred to as “sheet transporting direction”). The fixing device 24 fixes the toner images on the sheet P with heat and pressure.

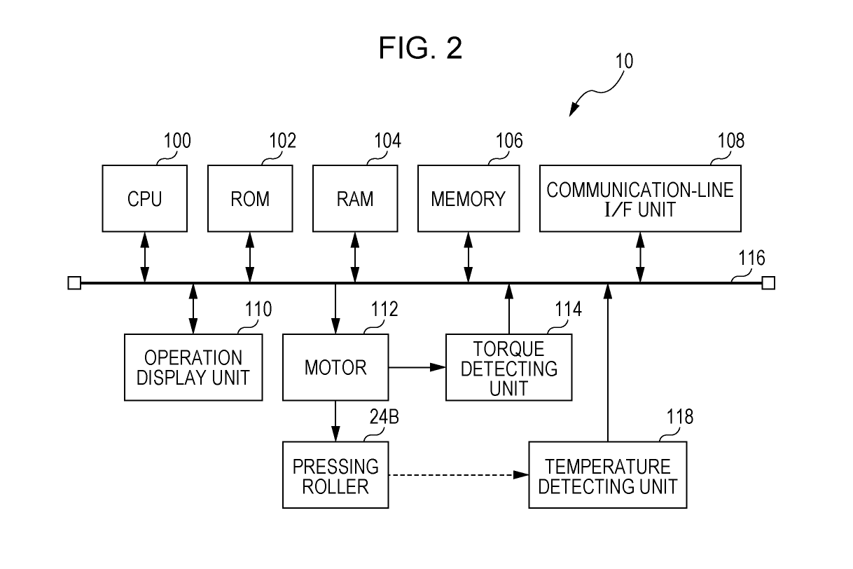

The fixing device 24 according to the present exemplary embodiment includes a heating belt 24A and a pressing roller 24B that are a pair of rotating bodies. The fixing device 24 is a so-called induction-heating (IH) fixing device in which the heating belt 24A is caused to generate heat by the effect of electromagnetic induction. The pressing roller 24B is driven (rotated) by a motor 112 (see FIG. 2) as an exemplary driving portion. The heating belt 24A rotates by following the rotation of the pressing roller 24B.

A pair of discharge rollers 28 are provided on the downstream side with respect to the fixing device 24 in the sheet transporting direction. The pair of discharge rollers 28 discharges the sheet P having the fixed toner images to an output portion 26 provided at the top of the apparatus body 10A of the image forming apparatus 10.

The feed-and-transport unit 30 that feeds and transports the sheet P lies below the image forming units 16 and extends to and along one side of the image forming units 16. Four toner cartridges 14 (14K, 14C, 14M, and 14Y) filled with respective toners to be supplied to respective developing devices 38 are provided above the first transfer unit 18. The toner cartridges 14 are attachable to and detachable from the apparatus body 10A from the front side of the apparatus body 10A and are arranged side by side in the width direction of the image forming apparatus 10. The toner cartridges 14 for the respective colors each have a columnar shape extending in the depth direction of the image forming apparatus 10 and are each connected to the respective developing devices 38 with respective supply tubes (not illustrated).

### Image Forming Units

As illustrated in FIG. 1, the image forming units 16 for the respective colors all have the same configuration. Each of the image forming units 16 includes a round-columnar rotating image carrier 34, and a charger 36 that charges the surface of the image carrier 34.

The image forming unit 16 further includes a light-emitting-diode (LED) head 32 that forms an electrostatic latent image on the charged surface of the image carrier 34 by applying an exposure beam thereto, the developing device 38 that develops and visualizes the electrostatic latent image into a toner image by using a developer (in the present exemplary embodiment, a negatively charged toner), and a cleaning blade (not illustrated) that cleans the surface of the image carrier 34.

The developing device 38 includes a developing roller 39 provided facing the image carrier 34. The electrostatic latent image formed on the image carrier 34 is developed with the developer by the developing roller 39 and is thus visualized as a toner image.

The charger 36, the LED head 32, the developing roller 39, and the cleaning blade are arranged along the surface of the image carrier 34 in that order from the upstream side toward the downstream side in the direction of rotation of the image carrier 34.

### Transfer Portions (First Transfer Unit and Second Transfer Roller)

The first transfer unit 18 includes an endless intermediate transfer belt 42, a driving roller 46, a tension applying roller 48, an assisting roller 50, and first transfer rollers 52. The intermediate transfer belt 42 is stretched around the driving roller 46, the tension applying roller 48, the assisting roller 50, and the first transfer rollers 52. The driving roller 46 is rotated when driven by a motor (not illustrated) and thus rotates the intermediate transfer belt 42 in a direction of an arrow A. The tension applying roller 48 applies tension to the intermediate transfer belt 42. The assisting roller 50 is provided above the tension applying roller 48 and rotates by following the rotation of the intermediate transfer belt 42. The first transfer rollers 52 are provided across the intermediate transfer belt 42 from the respective image carriers 34.

In the above configuration, toner images in the respective colors Y, M, C, and K that are formed on the image carriers 34 of the respective image forming units 16 are transferred to the intermediate transfer belt 42 by the respective first transfer rollers 52 in such a manner as to be superposed one on top of another.

A cleaning blade 56 that cleans the surface of the intermediate transfer belt 42 by being in contact therewith is provided across the intermediate transfer belt 42 from the driving roller 46.

The second transfer roller 22 that transfers the toner images on the intermediate transfer belt 42 to the sheet P that is transported thereto is provided across the intermediate transfer belt 42 from the assisting roller 50. The second transfer roller 22 is grounded. The assisting roller 50 serves as a counter electrode for the second transfer roller 22. A second transfer voltage is applied to the assisting roller 50, whereby the toner images are transferred to the sheet P. In the present exemplary embodiment, for example, the speed of transport of the sheet P by the second transfer roller 22 and the intermediate transfer belt 42 is faster than the speed of transport of the sheet P by the fixing device 24.

### Feed-And-Transport Unit

The feed-and-transport unit 30 provided in the apparatus body 10A includes a sheet container 62 provided below the image forming units 16. Plural sheets P are contained in the sheet container 62.

The feed-and-transport unit 30 further includes a feed roller 64, a pair of separating rollers 66, and a pair of registration rollers 68 that are arranged in that order from the upstream side toward the downstream side in the sheet transporting direction. The feed roller 64 feeds some of the sheets P contained in the sheet container 62 into the transport path 60. The pair of separating rollers 66 separate one of the sheets P fed by the feed roller 64 from the others. The pair of registration rollers 68 adjust the timing of transporting the sheet P.

The pair of registration rollers 68 are connected to a motor (not illustrated) that drives and thus rotates the pair of registration rollers 68 with a clutch mechanism (not illustrated) interposed therebetween. In the image forming apparatus 10, the clutch mechanism is disconnected from the pair of registration rollers 68 until the sheet P reaches the pair of registration rollers 68. Therefore, the leading end of the sheet P in the sheet transporting direction knocks against the pair of registration rollers 68. Thus, in the image forming apparatus 10, any tilt of the sheet P with respect to the sheet transporting direction is corrected; that is, the sheet P is registered. After the sheet P is registered, the pair of registration rollers 68 are connected to the clutch mechanism and are rotated. Thus, the sheet P is transported.

In the above configuration, the sheet P fed from the sheet container 62 is transported by the pair of rotating registration rollers 68 at a predetermined timing to a portion (second transfer position) where the intermediate transfer belt 42 and the second transfer roller 22 are in contact with each other.

The sheet P is then transported to the fixing device 24, where the sheet P is heated by the heating belt 24A and is pressed between the heating belt 24A and the pressing roller 24B, whereby the toner images on one side (an image forming side) of the sheet P are fixed.

The feed-and-transport unit 30 further includes a duplex transporting device 70 that is used before the sheet P on one side of which the toner images have been fixed by the fixing device 24 is discharged onto the output portion 26 by the pair of discharge rollers 28 and if other toner images are formed on the other side of the sheet P.

The duplex transporting device 70 includes a duplex transport path 72 in which the sheet P is turned over by being transported from the pair of discharge rollers 28 to the pair of registration rollers 68, and pairs of transport rollers 74 and 76 that transport the sheet P along the duplex transport path 72.

The image forming apparatus 10 may include a sheet identifying sensor provided on at least one of the upstream side and the downstream side with respect to the fixing device 24 on the transport path 60. The sheet identifying sensor may be, for example, a reflection-type sensor including a pair of light-emitting element and a light-receiving element. In that case, the sheet identifying sensor applies light from the light-emitting element to an identifying position on the transport path 60 that corresponds to the position where the light-receiving element is provided. The sheet identifying sensor outputs a signal (hereinafter referred to as “identifying signal”) at a level corresponding to the quantity of light received by the light-receiving element. While the sheet P is being transported over the identifying position, the light emitted from the light-emitting element is reflected by the sheet P. Hence, the level of the identifying signal that is outputted by the sheet identifying sensor is different between that outputted while the sheet P is being transported over the identifying position and that outputted while no sheet P is being transported over the identifying position. The sheet identifying sensor may be any other sensor such as a transmission-type sensor, instead of the above reflection-type sensor.

### Image Forming Process

First, the image processing portion 12 outputs pieces of gray-scale data for the respective colors to the respective LED heads 32. The LED heads 32 emit exposure beams in accordance with the pieces of gray-scale data, respectively. The exposure beams are applied to the surfaces of the image carriers 34 that are charged by the chargers 36, respectively, whereby electrostatic latent images are formed on the surfaces of the image carriers 34, respectively. The electrostatic latent images on the image carriers 34 are developed by the developing devices 38 and are thus visualized as toner images in the colors Y, M, C, and K, respectively.

The toner images in the respective colors on the image carriers 34 are transferred to the rotating intermediate transfer belt 42 by the first transfer rollers 52 of the first transfer unit 18 in such a manner as to be superposed one on top of another.

The toner images in the respective colors superposed on the intermediate transfer belt 42 are transferred by the second transfer roller 22 at the second transfer position to a sheet P transported thereto from the sheet container 62 along the transport path 60 by the feed roller 64, the pair of separating rollers 66, and the pair of registration rollers 68.

The sheet P now having the toner images is transported to the fixing device 24, and the toner images are fixed to the sheet P by the fixing device 24. The sheet P now having the fixed toner images is discharged to the output portion 26 by the pair of discharge rollers 28.

If images are to be formed on both sides of the sheet P, the sheet P having the toner images fixed to one side (front side) thereof by the fixing device 24 is not discharged to the output portion 26 by the pair of discharge rollers 28. The pair of discharge rollers 28 rotate backward, whereby the direction of transport of the sheet P is changed. Thus, the sheet P is transported along the duplex transport path 72 by the pairs of transport rollers 74 and 76.

The sheet P is turned over by being transported along the duplex transport path 72 and reaches the pair of registration rollers 68 again. Subsequently, other toner images are transferred to the other side (back side) of the sheet P and are fixed. Then, the sheet P is discharged to the output portion 26 by the pair of discharge rollers 28.

Referring now to FIG. 2, relevant elements included in an electrical system of the image forming apparatus 10 according to the present exemplary embodiment will be described. FIG. 2 is a block diagram illustrating relevant elements included in the electrical system of the image forming apparatus 10 according to the present exemplary embodiment.

As illustrated in FIG. 2, the image forming apparatus 10 according to the present exemplary embodiment includes a central processing unit (CPU) 100 that controls the entire operation of the image forming apparatus 10, a read-only memory (ROM) 102 that originally stores associated information such as programs and parameters, a random access memory (RAM) 104 that is used as a work area or the like when any programs are executed by the CPU 100, and a nonvolatile memory 106 such as a flash memory.

The image forming apparatus 10 further includes a communication-line interface (I/F) unit 108 that transmits and receives communication data to and from external apparatuses, and an operation display unit 110 that accepts instructions made to the image forming apparatus 10 by a user and displays associated information such as the operational status of the image forming apparatus 10 to the user. The operation display unit 110 includes, for example, a display with a touch panel on which associated pieces of information and buttons for accepting operational instructions are displayed when any program is executed, and a hardware keyboard including a numerical keypad and a start button.

The image forming apparatus 10 further includes a torque detecting unit 114 as an exemplary detecting portion that detects the load (torque) applied to the motor 112 that drives the pressing roller 24B to rotate. The torque detecting unit 114 according to the present exemplary embodiment is connected to the motor 112 and detects the torque of the motor 112 as the value of a current flowing through the motor 112.

The configuration of the torque detecting unit 114 according to the present exemplary embodiment is not specifically limited, as long as the torque detecting unit 114 is capable of detecting the torque of the motor 112. For example, the torque detecting unit 114 may be any of the following: a unit that detects the torque of the motor 112 as the value of a current flowing through the motor 112 and outputs a voltage value obtained by converting the detected current value, a unit that detects the current by measuring the voltage between shunt resistors, a unit that detects the current by measuring the voltage between resistors that are provided on a path of the current flowing through the motor 112, a unit that detects the current by using a current sensor including a Hall device and provided on a path of the current flowing through the motor 112, and a torque detector that detects the torque of the motor 112.

The CPU 100, the ROM 102, the RAM 104, the memory 106, the communication-line I/F unit 108, the operation display unit 110, the motor 112, and the torque detecting unit 114 are connected to one another by being connected to a bus 116 including an address bus, a data bus, a control bus, and the like.

The CPU 100 of the image forming apparatus 10 according to the present exemplary embodiment that is configured as described above allows access to the ROM 102, the RAM 104, and the memory 106 and transmission and reception of communication data to and from external apparatuses via the communication-line I/F unit 108. Furthermore, the CPU 100 of the image forming apparatus 10 acquires information on associated instructions made on the operation display unit 110 and displays such information on the operation display unit 110. Furthermore, the CPU 100 of the image forming apparatus 10 controls the motor 112 and acquires the voltage value outputted from the torque detecting unit 114.

The image forming apparatus 10 according to the present exemplary embodiment has an identifying function in which the type of the sheet P is identified. The identifying function will now be described.

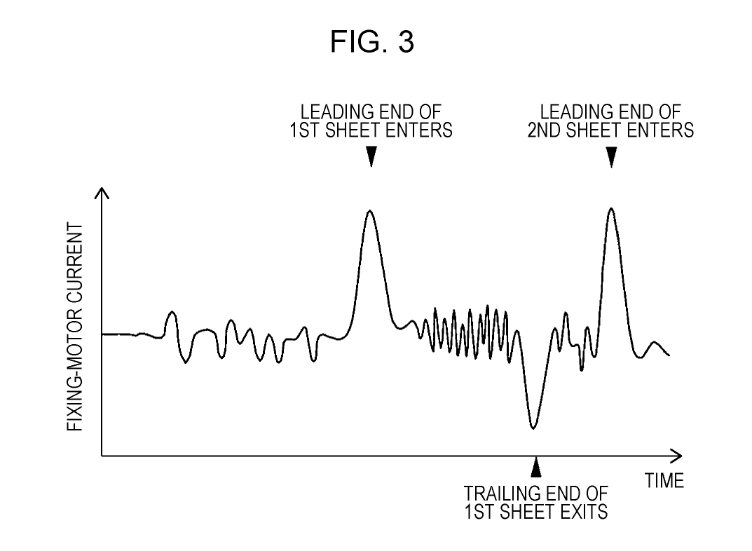

Referring to FIG. 3, when the sheet P enters the fixing device 24, the current value detected by the torque detecting unit 114 rapidly increases, whereby an upward peak appears. Subsequently, when the sheet P exits from the fixing device 24, the current value rapidly decreases, whereby a downward peak appears. The current values detected by the torque detecting unit 114, including the peak detected when the sheet P enters the fixing device 24, the peak detected when the sheet P exits from the fixing device 24, and the value detected while the sheet P is passing through the fixing device 24, vary with the type (thickness) of the sheet P. In the identifying function according to the present exemplary embodiment, the fact that the current detected by the torque detecting unit 114 varies with the type of the sheet P is utilized. The CPU 100 identifies the type of the sheet P by acquiring the result of the detection by the torque detecting unit 114.

Specifically, in the present exemplary embodiment, the type of the sheet P is identified by calculating the difference between the peak value observed when the sheet P enters the fixing device 24 and the average of current values detected by the torque detecting unit 114 before the sheet P enters the fixing device 24 (the difference is hereinafter referred to as “differential current”) and then comparing the calculated difference and a threshold. While the present exemplary embodiment concerns a case where the peak value refers to the largest or smallest value that forms the peak of the graph, the present invention is not limited to such a case. A value close to the peak value may be taken. Such a value is also regarded as the peak value in the present exemplary embodiment. The peak value of the current may be obtained within a certain current-sampling period (sampling rate).

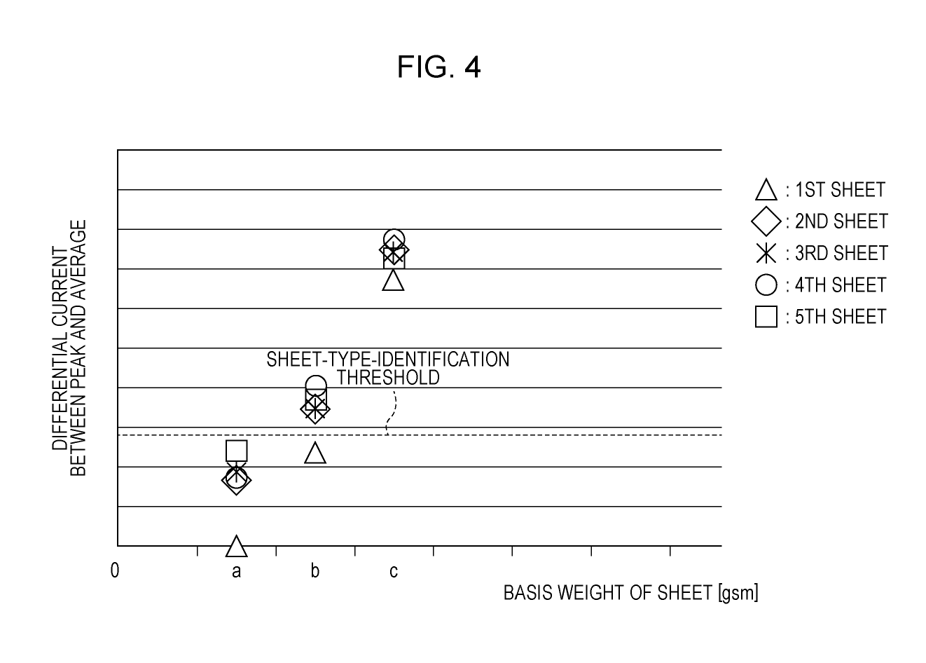

In the above identifying function, there is a wide variation in the current observed when the sheet P enters the fixing device 24. Hence, if the type of the sheet P is identified with reference to a constant threshold, the type of the sheet P may be misidentified. For example, referring to FIG. 4, if sheets P having a basis weight (i.e., thickness) a and sheets P having a basis weight b are subjected to sheet-type identification with reference to a constant sheet-type-identification threshold, the first one of the sheets P having the basis weight b may be misidentified as a sheet P having the basis weight a, because the differential current varies significantly between that for the first sheet P and those for the second and subsequent sheets P.

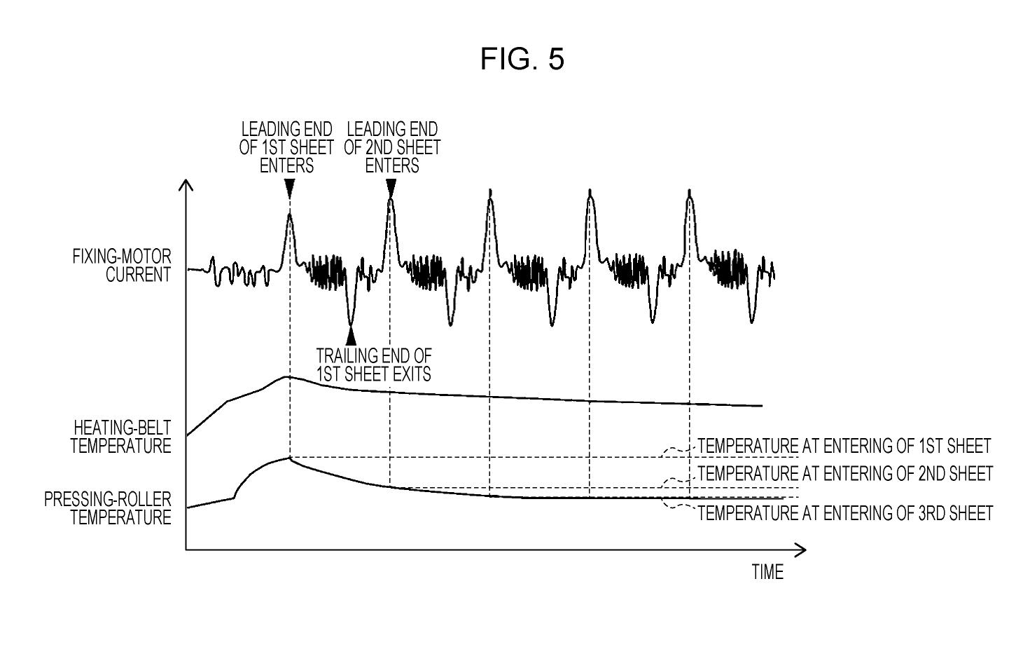

One of factors that cause such misidentification of the sheet type will now be described with reference to FIG. 5. FIG. 5 is a graph illustrating the current of the motor 112 observed during image formation (hereinafter also referred to as “fixing-motor current”), the temperature of the heating belt 24A, and the temperature of the pressing roller 24B that all change with time.

In the present exemplary embodiment, before the sheet P enters the fixing device 24, the pressing roller 24B is brought into contact with the heating belt 24A, whereby the temperature of the pressing roller 24B gradually rises. Hence, as graphed in FIG. 5, the temperature of the pressing roller 24B at the entering of the leading end of the first sheet P into the fixing device 24 is higher than the temperatures of the pressing roller 24B at the entering of the leading ends of the second and subsequent sheets P. Accordingly, the hardness of the pressing roller 24B and the current (the entering current) at the entering of the leading end of the sheet P are lower for the first sheet P than those for the second and subsequent sheets P. Consequently, as graphed in FIG. 4, the first one of the sheets P having the basis weight b is misidentified as a sheet P having the basis weight a.

For the second and subsequent sheets P, the temperature of the pressing roller 24B is saturated after the passage of the first sheet P. Therefore, the variation in the entering current is reduced, and the occurrence of misidentification is suppressed.

Hence, in the present exemplary embodiment, a temperature detecting portion 118 (see FIG. 2) that detects the temperature of the pressing roller 24B is provided, and the threshold that is referred to in the identifying function is set in accordance with the temperature of the pressing roller 24B that is detected by the temperature detecting portion 118.

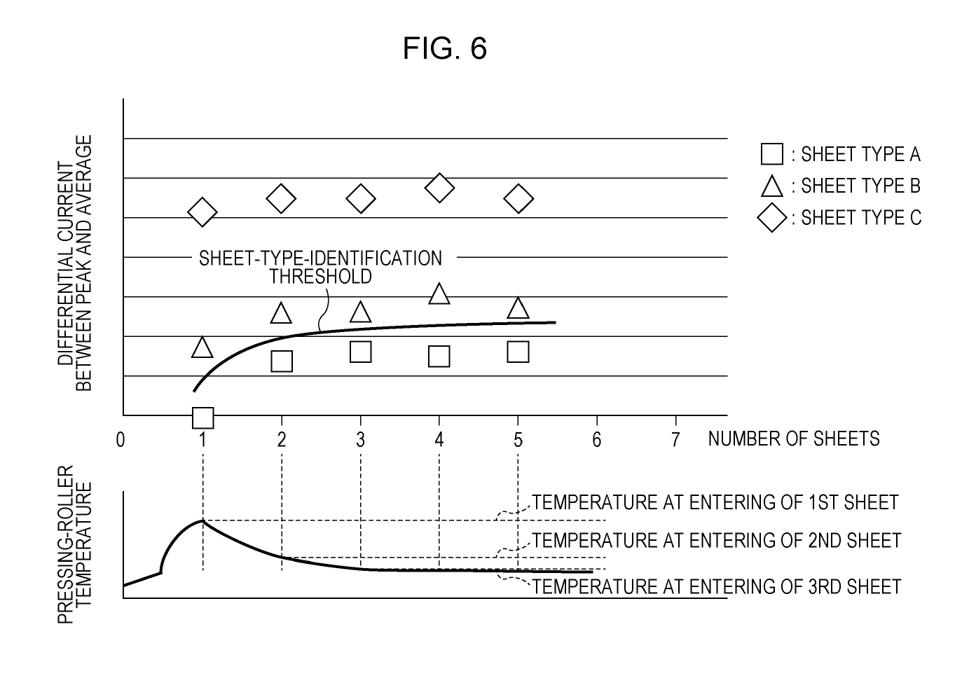

For example, different values of the threshold that correspond to different temperatures (for example, values of the sheet-type-identification threshold graphed in FIG. 6) are defined in advance and are stored in a device such as the ROM 102 or the memory 106, and one of the values that corresponds to the temperature detected by the temperature detecting portion 118 is taken as the threshold. In the present exemplary embodiment, a sheet-type-identification program as an exemplary medium-type-identification program in which the type of the sheet P is identified while the value of the threshold is changed in accordance with the temperature of the pressing roller 24B is stored in advance in the ROM 102. While FIG. 6 illustrates only values of a threshold taken in a case where sheets P of type A and sheets P of type B are used, values of a threshold taken in a case where sheets P of type B and sheets P of type C are used may also be defined in accordance with the temperature.

Referring to FIG. 2, the temperature detecting portion 118 is connected to the bus 116 and detects the temperature of the pressing roller 24B. The present exemplary embodiment concerns a case where the temperature detecting portion 118 detects the temperature of the pressing roller 24B. Alternatively, the temperature detecting portion 118 may detect the temperature of the heating belt 24A. Moreover, the temperature detecting portion 118 may detect the temperatures of the heating belt 24A and the pressing roller 24B for determination of the threshold.

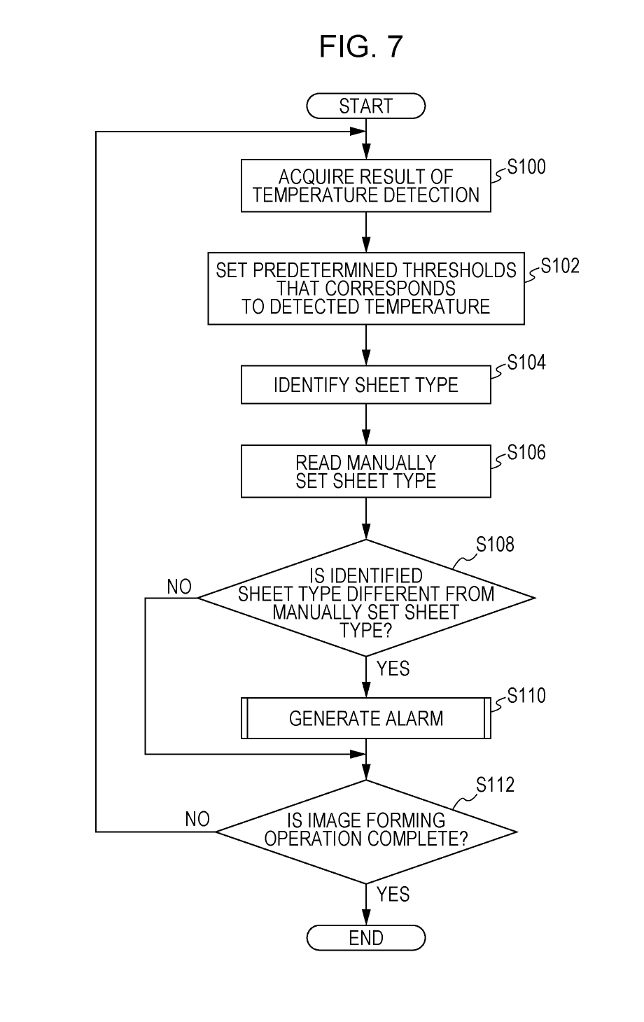

Now, the above process performed in the image forming apparatus 10 according to the present exemplary embodiment will be described more specifically. FIG. 7 is a flow chart illustrating an exemplary process performed in the image forming apparatus 10 according to the present exemplary embodiment. The process illustrated in FIG. 7 is started as follows. When an image-formation instruction is made on the operation display unit 110, the CPU 100 executes the sheet-type-identification program stored in the ROM 102. Note that, when the image-formation instruction is made, the type of sheets P to be used is set manually on the operation display unit 110.

In step S100, the CPU 100 acquires the temperature of the pressing roller 24B that is detected by the temperature detecting portion 118. Then, the process proceeds to step S102.

In step S102, the CPU 100 sets a predetermined threshold in accordance with the temperature of the pressing roller 24B that has been detected by the temperature detecting portion 118. Then, the process proceeds to step S104.

In step S104, the CPU 100 identifies the sheet type on the basis of a value detected by the torque detecting unit 114 and the threshold that has been set as above. Then, the process proceeds to step S106. For example, referring to FIG. 6, the sheet type is identified by checking if the difference between the peak value and the average value of the current (i.e., the differential current) detected by the torque detecting unit 114 is higher than or lower than the sheet-type-identification threshold that has been set in accordance with the detected temperature. As mentioned above, FIG. 6 illustrates only values of a sheet-type-identification threshold taken in a case where sheets P of type A and sheets P of type B are used. In the case illustrated in FIG. 6, the sheet type is determined as A if the differential current is lower than the sheet-type-identification threshold; whereas the sheet type is determined as B if the differential current is higher than the sheet-type-identification threshold.

In step S106, the CPU 100 reads the sheet type that has been set manually on the operation display unit 110 in making the image-formation instruction. Then, the process proceeds to step S108.

In step S108, the CPU 100 checks if the sheet type identified in step S104 is different from the sheet type read in step S106. If the two are different, the process proceeds to step S110. If the two are the same, the process proceeds to step S112.

In step S110, the CPU 100 generates an alarm notifying that the sheet type having been set manually on the operation display unit 110 is different from the actual sheet type. Then, the process proceeds to step S112. That is, if the manually set sheet type is different from the actual sheet type, the conditions of the fixing device 24 do not match with the sheet type. Such a situation may lead to a defective image with low quality or the like. Hence, if the manually set sheet type is different from the actual sheet type, the alarm is generated. For example, after the image forming operation is stopped, the alarm is generated as an indication displayed on the operation display unit 110 or the like. Then, if an instruction for continuing the image forming operation is made on the operation display unit 110, the process proceeds to step S112. If an instruction for aborting the image forming operation is made, the process is terminated. If an alarm is generated again after the instruction for continuing the image forming operation is made and the operation is continued, the generation of the alarm for the second and subsequent times may be skipped until the image forming operation is complete.

In step S112, the CPU 100 checks if the image forming operation is complete. This step is performed by checking if the formation of images on all pages that are requested for image formation is complete. If the formation of images on all pages is not complete, the process returns to step S100 and the above-described process is performed again. If the formation of images on all pages is complete, the process ends.

In the present exemplary embodiment, as described above, different thresholds for identifying the sheet type are defined for different temperatures of the pressing roller 24B. That is, a threshold is set with consideration for the variation in the entering current that occurs with the change in the temperature of the pressing roller 24B. Therefore, the occurrence of misidentification of the sheet type is suppressed.

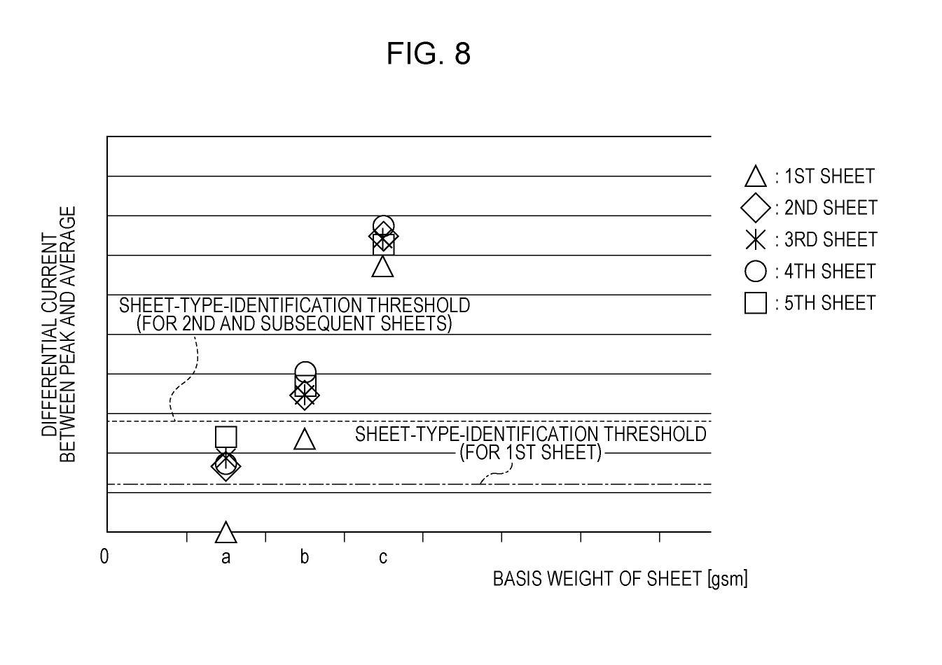

While the above exemplary embodiment concerns a case where the threshold for identifying the sheet type is defined in accordance with the temperature of the pressing roller 24B, the threshold may be defined in accordance with the number of pages on which images are to be formed. As described above, the differential current varies between that for the first sheet and those for the second and subsequent sheets in a single image-forming instruction. Therefore, even if the threshold is set in accordance with the number of images (pages) as graphed in FIG. 8, the occurrence of misidentification of the sheet type is suppressed as in the above exemplary embodiment. In that case, the temperature detecting portion 118 may be omitted. While FIG. 8 illustrates a case where different sheet-type-identification thresholds are defined for the first sheet and the second and subsequent sheets, the threshold may be changed at another point, not between the first sheet and the second and subsequent sheets, depending on the type or another factor of the pressing roller 24B. Moreover, while FIG. 8 illustrates only the sheet-type-identification thresholds for distinguishing sheets having the basis weight a and sheets having the basis weight b from each other, thresholds for distinguishing sheets having the basis weight b and sheets having the basis weight c from each other may be defined in the same manner.

While the above exemplary embodiment concerns a case where the process illustrated in FIG. 7 is performed by causing a computer to execute the sheet-type-identification program, a part or the entirety of the process started with the execution of the sheet-type-identification program may be performed by using hardware.

The process performed by the CPU 100 of the image forming apparatus 10 according to the above exemplary embodiment may be stored as a program in a storage medium and may be commercially distributed.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A fixing device comprising:
a fixing portion configured to fix an image formed on a medium;
a driving portion configured to drive the fixing portion;
a detecting portion configured to detect a torque applied to the driving portion;
at least one processor configured to perform the following:
identify a type of the medium based on the torque and a threshold; and
set the threshold in such a way that the threshold decreases as a temperature of the fixing portion increases.

2. (canceled)

3. (canceled)

4. A fixing device comprising:
a fixing portion configured to fix an image formed on a medium;
a driving portion configured to drive the fixing portion;
a detecting portion configured to detect a torque applied to the driving portion when the sheet enters the fixing portion;
at least one processor configured to perform the following:
identify a type of the medium based on the torque and a threshold; and
set the threshold based on a temperature of the fixing portion when the sheet enters the fixing portion.

5. The fixing device according to claim 1,
wherein a fixing portion is a pressing roller.

6. The fixing device according to claim 4,
wherein a fixing portion is a pressing roller.

7. The fixing device according to claim 1,
wherein detects the torque as a value of a current flowing through the driving portion.

8. The fixing device according to claim 4,
wherein detects the torque as a value of a current flowing through the driving portion.

9. A fixing device comprising:
a fixing portion configured to fix an image formed on a medium;
a driving portion configured to drive the fixing portion;
a detecting portion configured to detect a torque applied to the driving portion;
at least one processor configured to perform the following:
identify a type of the medium based on the torque and a threshold;
set the threshold based on a temperature of the fixing portion when the sheet enters the fixing portion such that the threshold decreases as the temperature of the fixing portion increases.
